(19) United States
(12) Patent Application Publication
(10) Pub. No.: US 2009/0107597 A1
(43) Pub. Date: Apr. 30, 2009

(54) TIRE WITH WEAR RESISTANT RUBBER TREAD

(76) Inventors: Bernd Richard Loewenhaupt, Rohrheim (DE); Bernd Zotz, Bruchkoebel (DE); Wolfgang Karl Maegerle, Erlensee (DE)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/924,855

(22) Filed: Oct. 26, 2007

(51) Int. Cl. B60C 1/00; B60C 19/08

(52) U.S. Cl. 152/209.5; 152/152.1

(57) ABSTRACT

The invention relates to a tire having a composite rubber tread band disposed circumferentially around a tire carcass. The tread band is comprised of a cap/base construction composed of an outer tread cap rubber layer which provides a primary portion of the running surface for the tire tread and a unitary tread base layer underlying said tread cap layer which extends radially outward to the tread running surface to provide a secondary portion of the running surface of the tread. The rubber composition of said tread base layer and the corresponding secondary lateral portion of the running surface of the tread has a greater resistance to wear than the rubber composition of said tread cap layer.

### FIELD OF THE INVENTION

The invention relates to a tire having a composite rubber tread band disposed circumferentially around a tire carcass. The tread band is comprised of a cap/base construction composed of an outer tread cap rubber layer which provides a primary portion of the running surface for the tire tread and a unitary tread base layer underlying said tread cap layer which extends radially outward to the tread running surface to provide a secondary portion of the running surface of the tread. The rubber composition of said tread base layer and the corresponding secondary lateral portion of the running surface of the tread has a greater resistance to wear than the rubber composition of said tread cap layer.

### BACKGROUND FOR THE INVENTION

Tire treads for pneumatic tires typically have running surfaces of consistent rubber properties across the face of the tread intended to be ground contacting.

Sometimes one or more of the peripheral, or lateral, portions of the running surface of the tread may tend to experience a greater rate of wear than the more central portion of the tread running surface.

For this invention, a tread running surface is provided which is composed of a two or three zones, namely a primary running surface zone and one or two lateral running surface zone(s) located at a lateral peripheral portion of the tread running surface, wherein the lateral running surface zone(s) is(are) of a rubber composition having a greater resistance to abrasion, or wear, than the rubber composition of the primary running tread running surface.

The tread cap layer and tread base layer thereby provide two distinct circumferential load-bearing tread running surface zones which contain reinforcing fillers selected from precipitated silica and carbon black. The rubber tread cap layer and rubber tread base layer are co-extruded together to form an integral tread rubber composite.

In practice, the rubber composition of the tread rubber base layer and its associated tread running surface contains sufficient rubber reinforcing carbon black so that an electrically conductive path is provided from the tread base layer radially outward to the running surface of the tire.

Historically, tires have been heretofore been suggested which contain at least three circumferential portions intended to promote various properties for the running surface of the tire tread. For example, see U.S. Pat. No. 6,959,744 for a tread having lateral wear resistant properties, and U.S. Pat. No. 7,131,474 as well as EP 0 993 381 A3, FR 2765525 and WO 99/01299 patent publications.

The tire tread running surface of the present invention is contrary to the above patent publications. For this invention, a tire tread of two or more (for example two or three) significantly wide, distinct load-bearing running surface zones, namely a primary tread running surface and one or two, preferably one, outboard, lateral tread running surface(s) of which the lateral tread running surface(s) have greater wear resistance than the primary running surface, each of which contain carbon black reinforcement and are thereby black in color and for which the lateral tread running surface zone tread and base rubber layer are of a unified rubber composition.

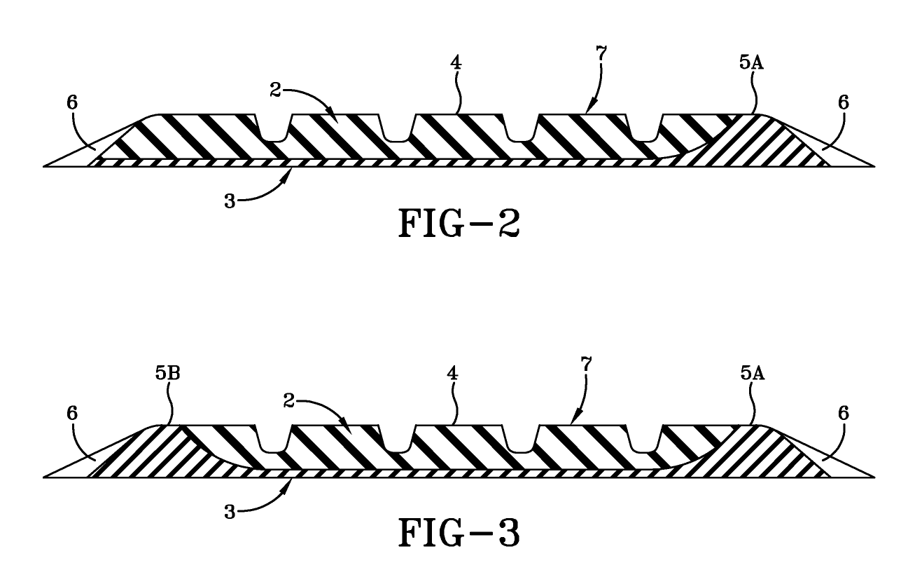

Historically, European patent publication number EP 864,446 A1 relates to a tire having a tread (FIG. 2) with a central portion (B) and side portions (A) positioned directly onto a tire carcass belt without a tread base transition layer. The side portions are carbon black rich and the central portion is silica rich, wherein the silica content of the central portion (B) is at least 20 percent higher than in the side portions (A).

By requiring the tread running surface zones of the tread of this invention to be load-bearing, it is meant that each of the two or more (for example two or three) distinct tread running surfaces, namely the primary tread zone and the lateral tread zone(s), extend radially inward from the outer surface of the tread to the underlying carbon black-rich tread base rubber composition (with the lateral tread running surface zone(s) being unified with and of the same rubber composition and thereby a part of said tread base rubber layer) so that all of the load on the tire is communicated by the tread running surface zones directly to the tread base layer instead of directly to remainder of the tire carcass itself.

By requiring that each of the running surface tread zones be significantly wide, and therefore each comprising a significant portion of the tread running surface, it is intended that each respective zone, including the later tread running surface zone, to more effectively transmit a significant load from the outer surface of the running surface of the tire directly radially inward to the supportive tread base layer. In practice and as one embodiment of the invention, the primary tread running surface zone spans from about 60 to about 95 percent of the width of the tread running surface and the lateral tread zone(s) spans from about 5 to about 40 percent of the width of the tread running surface. In practice, each individual lateral running surface is preferably at least 2 cm wide at the tread running surface and more preferably from 2 cm to 10 cm wide at the tread running surface. Such span of the tread running surface is the surface of the tread lugs of the tread cap layer intended to be ground-contacting inclusive of the tread groove openings which extend to the running surface.

For this invention, the primary tread cap running surface zone may be comprised of a silica-rich, carbon black-containing rubber composition.

The lateral tread running surface zone(s), and corresponding tread base rubber layer is comprised of a carbon black-rich rubber composition zones which contain reinforcement filler as both carbon black and precipitated silica reinforcement.

A significant aspect of the invention is the providing of a tire tread of a cap/base construction with a primary running surface and at least one lateral running surface, preferably an asymmetrical running surface comprised of a primary running surface and one lateral running surface, where the lateral running surface has a greater wear resistance than the primary running surface and where the rubber composition of the lateral running surface is a projection of, unified with and of the same rubber composition as the tread base layer.

This is considered herein as being particularly significant in the sense that a significant portion (e.g. at least 5 percent) or the running surface is the projected tread base layer which further constitutes a path of reduced electrical resistance for the tire tread.

Accordingly, a significant aspect of the invention is the significantly transversally (axially) wide individual circumferential load bearing tread cap zones which extend radially from the tread cap running surface to the underlying, supportive tread base layer rather than more simply only extending directly to the tire carcass and particularly only to a tire carcass belt layer, with the rubber composition of the lateral tread zone being a part of and of the same rubber composition as the tread base rubber layer.

In particular, it is considered herein that providing a tire tread having a lateral portion of its running surface, particularly together with a tread base layer having a higher resistance to wear than the remainder of the tread running surface is a significant departure from past practice.

Therefore, a purpose of such tread cap zone configuration is to provide a running surface for a tire composed of the two, rather than three, circumferential load bearing zones in which the rubber composition for the lateral tread running surface zone is intended to promote resistance to abrasion, or tread wear, of a lateral portion of the running surface of the tread.

The tread cap lateral zone rubber composition contains both precipitated silica and rubber reinforcing carbon black reinforcement with the carbon black content being greater than the precipitated silica content. The primary tread cap zone rubber composition is a silica rich rubber composition which contains both precipitated silica and rubber reinforcing carbon black reinforcement silica with the precipitated silica content being greater than the carbon black content.

In the description of this invention, the terms “rubber” and “elastomer” where herein, are used interchangeably, unless otherwise provided. The terms “rubber composition”, “compounded rubber” and “rubber compound”, if used herein, are used interchangeably to refer to “rubber which has been blended or mixed with various ingredients and materials” and such terms are well known to those having skill in the rubber mixing or rubber compounding art.

In the description of this invention, the term “phr” refers to parts of a respective material per 100 parts by weight of rubber, or elastomer. The terms “rubber” and “elastomer” may be used interchangeably unless otherwise provided. The terms “cure” and “vulcanize” may be used interchangeably unless otherwise provided.

### SUMMARY AND PRACTICE OF THE INVENTION

In accordance With this invention, a tire is provided having a rubber tread of a co-extruded cap/base layered construction with a running (ground contacting) surface, wherein said cap/base configured tread is comprised of an outer tread cap rubber layer and a tread base rubber layer underlying said outer tread cap rubber layer,

wherein tread said is of a lug and groove configuration,

wherein said tread running surface is comprised of a primary tread zone comprised of said outer tread cap rubber layer and one or two lateral (peripheral) tread zones, preferably one lateral tread zone,

wherein said lateral tread zone(s) are comprised of said tread base rubber layer which extends radially outward from and as a part of said base rubber layer to the running surface of the tread,

wherein said lateral tread zone(s) are positioned axially outboard of said primary tread zone,

wherein said tread zones extend radially inward from the running surface of the tread to said tread base layer, wherein, based upon parts by weight per 100 parts by weight rubber (phr)

(A) said tread base layer and said lateral tread running surface zone(s) are of the same rubber composition and contain from about 40 to about 90 phr of rubber reinforcing filler comprised of:
(1) from about 20 to about 80, alternately from about 25 to about 65, phr of rubber reinforcing carbon black, and
(2) from about 10 to about 40, alternately about 5 to about 35, phr of precipitated silica, (thus, in one aspect, the rubber reinforcing and wherein the weight ratio said carbon black to said silica is in a range of from about 60/40 to about 80/20, and
(3) a coupling agent having a moiety reactive with hydroxyl groups (e.g. silanol groups) contained on the surface of said silica and another moiety interactive with said diene-based elastomer(s);

(B) said primary tread cap zone running surface is comprised of a rubber composition which contains from about 40 to about 100 phr of rubber reinforcing filler comprised of:
(1) about 40 to about 100, alternately about 30 to about 70, phr of precipitated silica, and
(2) from zero to about 40, alternately about 10 to about 30, phr of rubber reinforcing carbon black,
wherein the weight ratio of carbon black to silica is in a range between about 1/8 to about 1/1 (thus the silica is in the majority insofar as silica and carbon black are concerned);
(3) a coupling agent having a moiety reactive with hydroxyl groups (e.g. silanol groups) contained on the surface of said silica and another moiety interactive with said diene-based elastomer(s);

wherein said rubber composition of said lateral tread zone running surface and said tread base layer has a greater wear resistance than the primary tread running surface.

In one embodiment, said tread running surface is an asymmetrical running surface comprised of said primary running surface and one lateral tread running surface zone (as an outboard, peripheral tread running surface).

In another embodiment, said tread running surface contains two of said lateral tread running surface zones (as individual, spaced apart, outboard peripheral tread running surfaces) with the said primary tread running surface therebetween.

As hereinbefore mentioned, in one aspect of the invention, the said tread cap and tread base rubber layers are co-extruded together to form an integral and unified tread composite thereof.

The wear resistance of the lateral tread cap zones may, for example, be promoted by an inclusion of greater amount of cis 1,4-polybutadiene rubber the rubber composition, a rubber compounding aspect well known to those having skill in such art.

It is envisioned herein that the tread running surface might be provided, for example, with distinct zones, namely a primary running surface zone and one or two, preferably one, lateral zone where the lateral zone(s), and associated tread base layer, have a greater resistance to wear than the primary running surface zone promoted by use of low Tg elastomers and higher low strain shear modulus G′ and a primary running surface zone for which it is desired to promote traction for the tread promoted by higher Tg elastomers and reduced low shear strain modulus G′.

It is to be appreciated that one having skill in rubber compounding for tire treads can readily provide the tread zones with the indicated rubber composition properties with routine experimentation and without undue experimentation.

Therefore, the invention is directed to a structural configuration of a tire tread combined with distinct, zoned, individual rubber compositions for the running surface of the tread.

It is envisioned herein that the tread running surface zones might be provided, for example with a rubber composition having a low strain modulus G′ value in a range of, for example, from about 3 to about 30 MPa for the primary running surface zone and a rubber composition having a low strain modulus G′ value in a range of from 5 to about 50 MPa for the lateral zone.

It is envisioned herein that the rubber composition of the primary running surface zone might have, for example, a tan delta value at a low 10 percent strain at 10 hertz at 0° C. in a range of, for example, about 0.12 to about 0.50.

### BRIEF DESCRIPTION OF THE DRAWINGS

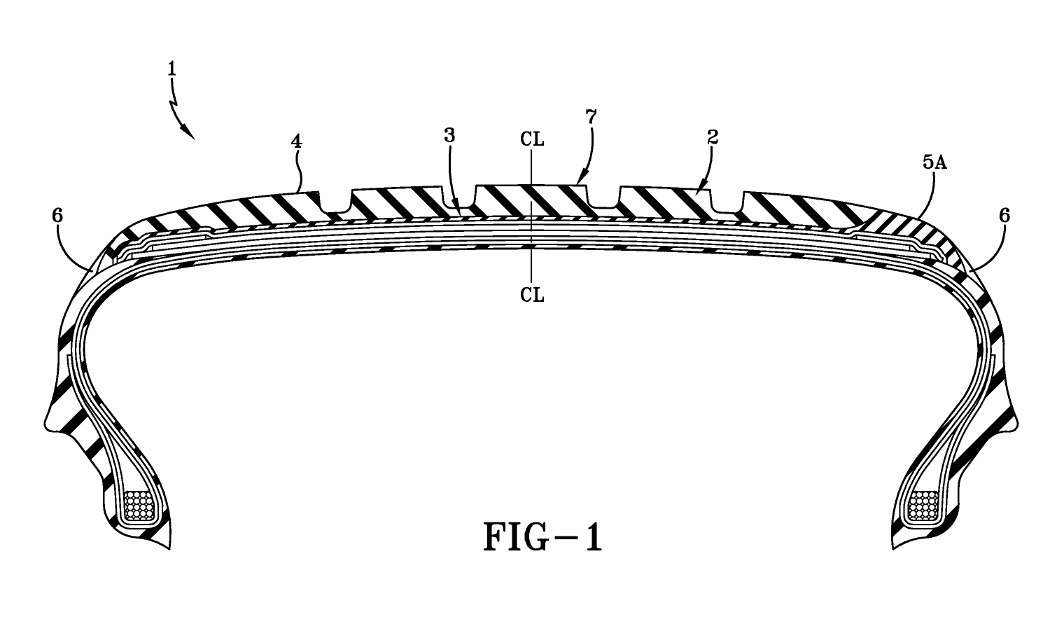

For a further understanding of this invention, drawings are provided in the sense of FIG. 1 (FIG. 1) a partial cross-sectional view of a tire having a tread of a cap/base construction, together with FIG. 2 (FIG. 2) and FIG. 3 (FIG. 3) as cross-sectional views of a tire tread strip.

### IN THE DRAWINGS

FIG. 1 depicts a tire (1) having a tread comprised of a tread cap layer (2) of a lug and groove configuration underlying tread base layer (3).

The asymmetrical tread running surface (7) is comprised of two annular, circumferential zones of rubber compositions comprised of a primary running surface zone (4) and a lateral, outboard, peripheral, asymmetrical tread running surface zone (5A).

The lateral tread running surface (5A) and the tread base rubber layer (3) are of the same rubber composition having a greater wear resistance than the primary tread running surface (4).

The two zones of the tread running surface (7) extend radially inward from the tread running surface (7) to the tread base layer (3) and not to the remainder of the carcass plies or carcass belt layer.

In particular, said primary tread running surface zone (4) and asymmetrical running surface lateral zone (5A) constitute the running surface of the tire (7) normally intended to be ground contacting with the outboard, peripheral edges of the running surface (7) slightly rounded to accommodate the turning and handling of the tire (1).

For FIG. 1, the primary tread running surface zone (4) is depicted as constituting about 90 percent of the tread running surface (7), although not depicted exactly to scale in FIG. 1, and the individual lateral asymmetrical running surface zone (5A) constitutes about 10 percent running surface of the tire tread (7).

For FIG. 2, a tread strip is shown having an asymmetrical running surface (7) comprised of the primary running surface (4) and individual lateral, peripheral tread running surface (5A) and outboard tread wings (6). The tire with the circumferential tread strip may be mounted on a vehicle with the lateral tread running surface (5A) positioned as an axially inner tread running surface relative to the associated vehicle or positioned as an axially outer tread running surface relative to the associated vehicle.

The unitary lateral tread running surface (5A) and tread base rubber layer (3) are of a rubber composition having a greater wear resistance than the primary tread running surface (4).

For FIG. 3, a tread strip is shown having its running surface (7) composed of two lateral tread running surfaces (5A) and (5B) with the primary tread running surface (4) positioned between the lateral running surfaces (5A) and (5B).

The unitary lateral tread running surfaces (5A) and (5B) and tread base rubber layer (3) are of a rubber composition having a greater wear resistance than the primary tread running surface (4).

In practice, the coupling agent for the respective rubber compositions of the tread which contain silica reinforcement may, for example, be comprised of an alkoxysilyl polysulfide such as for example, a bis(3-trialkoxysilylalkyl) polysulfide wherein alkyl radicals for said alkoxy groups are selected from one or more of methyl and ethyl radicals, preferably an ethyl radical and the alkyl radical for said silylalkyl component is selected from butyl, propyl and amyl radicals, preferably a propyl radical and wherein said polysulfide component contains from 2 to 8, with an average of from 2 to 2.6 or an average of from 3.5 to 4, connecting sulfur atoms in its polysulfidic bridge, preferably an average of from 2 to 2.6 connecting sulfur atoms to the exclusion of such polysulfides having greater than 2.6 connecting sulfur atoms.

Representative of such coupling agents are, for example, bis(3-triethoxysilylpropyl) polysulfide having an average of from 2 to 2.6 or an average of from 3.5 to 4, connecting sulfur atoms in its polysulfidic bridge, preferably an average of from 2 to 2.6 connecting sulfur atoms to the exclusion of a bis(3-triethoxysilanepropyl) polysulfide containing an average of greater than 2.6 connecting sulfur atoms in its polysulfidic bridge.

Such coupling agent may, for example, be added directly to the elastomer mixture or may be added as a composite of precipitated silica and such coupling agent formed by treating a precipitated silica therewith or by treating a colloidal silica therewith and precipitating the resulting composite.

In practice, the synthetic amorphous silica may be selected from aggregates of precipitated silica, which is intended to include precipitated aluminosilicates as a co-precipitated silica and aluminum.

Such precipitated silica is, in general, well known to those having skill in such art. For example, such precipitated silica may be precipitated by controlled addition of an acid such as, for example, hydrochloric acid or sulfuric acid, to a basic solution (e.g. sodium hydroxide) of a silicate, for example, sodium silicate, usually in the presence of an electrolyte, for example, sodium sulfate. Primary, colloidal silica particles typically form during such process which quickly coalesce to form aggregates of such primary particles and which are then recovered as precipitates by filtering, washing the resulting filter cake with water or an aqueous solution, and drying the recovered precipitated silica. Such method of preparing precipitated silica, and variations thereof, are well known to those having skill in such art.

The precipitated silica aggregates preferably employed in this invention are precipitated silicas such as, for example, those obtained by the acidification of a soluble silicate, e.g., sodium silicate and may include co-precipitated silica and a minor amount of aluminum.

Such silicas might usually be characterized, for example, by having a BET surface area, as measured using nitrogen gas, preferably in the range of about 40 to about 600, and more usually in a range of about 50 to about 300 square meters per gram.

The silica may also be typically characterized by having a dibutylphthalate (DBP) absorption value in a range of about 50 to about 400 cm³/100 g, and more usually about 100 to about 300 cm³/100 g.

Various commercially available precipitated silicas may be considered for use in this invention such as, only for example herein, and without limitation, silicas from PPG Industries under the Hi-Sil trademark with designations Hi-Sil 210, Hi-Sil 243, etc; silicas from Rhodia as, for example, Zeosil 1165MP™ and Zeosil 165GR™; silicas from J. M. Huber Corporation as, for example, Zeopol 8745™ and Zeopol 8715™ and silicas from Degussa AG with, for example, designations VN2™, VN3™ and Ultrasil 7005™ as well as other grades of silica, particularly precipitated silicas, which can be used for elastomer reinforcement.

Representative examples of other silica couplers may be organomercaptosilanes such as, for example, triethoxy mercaptopropyl silane, trimethoxy mercaptopropyl silane, methyl dimethoxy mercaptopropyl silane, methyl diethoxy mercaptopropyl silane, dimethyl methoxy mercaptopropyl silane, triethoxy mercaptoethyl silane, and tripropoxy mercaptopropyl silane.

In practice, the invention the rubber compositions may be prepared in a sequential series of at least two separate and individual preparatory internal rubber mixing steps, or stages, in which the diene-based elastomer is first mixed with the prescribed carbon black and/or silica in a subsequent, separate mixing step and followed by a final mixing step where curatives are blended at a lower temperature and for a substantially shorter period of time.

It is conventionally required after each mixing step that the rubber mixture is actually removed from the rubber mixer and cooled to a temperature of less than 40° C. and, for example, in a range of about 40° C. to about 20° C. and then added back to an internal rubber mixer for the next sequential mixing step, or stage.

The forming of a tire-component is contemplated to be by conventional means such as, for example, by extrusion of rubber composition to provide a shaped, unvulcanized rubber component such as, for example, a tire tread. Such forming of a tire tread is well known to those having skill in such art.

It is understood that the tire, as a manufactured article, is prepared by shaping and sulfur curing the assembly of its components at an elevated temperature (e.g. 140° C. to 180° C.) and elevated pressure in a suitable mold. Such practice is well known to those having skill in such art.

It is readily understood by those having skill in the art that the rubber composition would be compounded by methods generally known in the rubber compounding art, such as mixing the various sulfur-vulcanizable constituent rubbers with various commonly used additive materials, as herein before discussed, such as, for example, curing aids such as sulfur, activators, retarders and accelerators, processing additives, such as rubber processing oils, resins including tackifying resins, silicas, and plasticizers, fillers, pigments, fatty acid, zinc oxide, waxes, antioxidants and antiozonants, peptizing agents and reinforcing materials such as, for example, carbon black. As known to those skilled in the art, depending on the intended use of the sulfur vulcanizable and sulfur vulcanized material (rubbers), the additives mentioned above are selected and commonly used in conventional amounts.

Typical amounts of fatty acids, if used which can include stearic acid, comprise about 0.5 to about 3 phr. Typical amounts of zinc oxide comprise about 1 to about 5 phr. Typical amounts of waxes comprise about 1 to about 5 phr. Often microcrystalline waxes are used. Typical amounts of peptizers comprise about 0.1 to about 1 phr. Typical peptizers may be, for example, pentachlorothiophenol and dibenzamidodiphenyl disulfide.

The vulcanization is conducted in the presence of a sulfur vulcanizing agent. Examples of suitable sulfur vulcanizing agents include elemental sulfur (free sulfur) or sulfur donating vulcanizing agents, for example, an amine disulfide, polymeric polysulfide or sulfur olefin adducts. Preferably, the sulfur vulcanizing agent is elemental sulfur. As known to those skilled in the art, sulfur vulcanizing agents are used in an amount ranging from about 0.5 to about 4 phr, or even, in some circumstances, up to about 8 phr, with a range of from about 1.5 to about 2.5, sometimes from about 2 to about 2.5, being preferred.

Accelerators are used to control the time and/or temperature required for vulcanization and to improve the properties of the vulcanizate. In one embodiment, a single accelerator system may be used, i.e., primary accelerator. Conventionally and preferably, a primary accelerator(s) is used in total amounts ranging from about 0.5 to about 4, preferably about 0.8 to about 2.5, phr. In another embodiment, combinations of a primary and a secondary accelerator might be used with the secondary accelerator being used in smaller amounts (of about 0.05 to about 3 phr) in order to activate and to improve the properties of the vulcanizate. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. Suitable types of accelerators that may be used in the present invention are amines, disulfides, guanidines, thioureas, thiazoles, thiurams, sulfenamides, dithiocarbamates and xanthates. Preferably, the primary accelerator is a sulfonamide. If a second accelerator is used, the secondary accelerator is preferably a guanidine, dithiocarbamate or thiuram compound.

The mixing of the rubber composition can preferably be accomplished by the aforesaid sequential mixing process. For example, the ingredients may be mixed in at least three stages, namely, at least two non-productive (preparatory) stages followed by a productive (final) mix stage. The final curatives are typically mixed in the final stage which is conventionally called the “productive” or “final” mix stage in which the mixing typically occurs at a temperature, or ultimate temperature, lower than the mix temperature(s) of the preceding non-productive mix stage(s). The terms “non-productive” and “productive” mix stages are well known to those having skill in the rubber mixing art.

### EXAMPLE I

A tire is built having a tread of cap/base construction similar to FIG. 1 with a primary tread running surface and a lateral, peripheral tread running surface, where the lateral tread running surface and associated unitary tread base rubber layer are of the same rubber composition having a greater wear resistance than the rubber composition of the primary tread running surface.

While certain representative embodiments and details have been shown for the purpose of illustrating the invention, it will be apparent to those skilled in this art that various changes and modifications may be made therein without departing from the spirit or scope of the invention.

What is claimed is:

1. A tire having a rubber tread of a co-extruded cap/base layered construction with a running surface, wherein said cap/base configured tread is comprised of an outer tread cap rubber layer and a tread base rubber layer underlying said outer tread cap rubber layer,
wherein tread said is of a lug and groove configuration,
wherein said tread running surface is comprised of a primary tread zone comprised of said outer tread cap rubber layer and one or two lateral tread zones, wherein said lateral tread zone(s) are comprised of said tread base rubber layer which extends radially outward from and as a part of said base rubber layer to the running surface of the tread;
wherein said lateral tread zone(s) are positioned axially outboard of said primary tread zone,
wherein said tread zones extend radially inward from the running surface of the tread to said tread base layer, wherein, based upon parts by weight per 100 parts by weight rubber (phr)
(A) said tread base layer and said lateral tread funning surface zone(s) are of the same rubber composition and contain from about 40 to about 90 phr of rubber reinforcing filler comprised of:
(1) from about 20 to about 80, alternately from about 25 to about 65, phr of rubber reinforcing carbon black, and
(2) from about 10 to about 40, alternately about 5 to about 35, phr of precipitated silica, (thus, in one aspect, the rubber reinforcing and wherein the weight ratio said carbon black to said silica is in a range of from about 60/40 to about 80/20, and
(3) a coupling agent having a moiety reactive with hydroxyl groups (e.g. silanol groups) contained on the surface of said silica and another moiety interactive with said diene-based elastomer(s);
(B) said primary tread cap zone running surface is comprised of a rubber composition which contains from about 40 to about 100 phr of rubber reinforcing filler comprised of:
(1) about 40 to about 100, alternately about 30 to about 70, phr of precipitated silica, and
(2) from zero to about 40, alternately about 10 to about 30, phr of rubber reinforcing carbon black,
wherein the weight ratio of carbon black to silica is in a range between about 1/8 to about 1/1;
(3) a coupling agent having a moiety reactive with hydroxyl groups (e.g. silanol groups) contained on the surface of said silica and another moiety interactive with said diene-based elastomer(s);
wherein said rubber composition of said lateral tread zone running surface and said tread base layer have a greater wear resistance than the rubber composition of the primary tread running surface.

2. The tire of claim 1 wherein said tread running surface is an asymmetrical running surface comprised of said primary miming surface and said lateral tread running surface zone.

3. The tire of claim 1 wherein said tread running surface contains two of said lateral tread running surface zones with the said primary tread running surface therebetween.

4. The tire of claim 1 wherein said primary tread running surface zone spans from about 60 to about 95 percent of the width of the tread running surface and the lateral tread zone(s) spans from about 5 to about 40 percent of the width of the tread running surface, with each individual lateral running surface being at least 2 cm wide.

5. The tire of claim 4 wherein said tread running surface is comprised of said primary tread running surface and one lateral tread running surface and where said lateral tread running surface is from about 2 to about 10 cm wide.

6. The tire of claim 1 wherein said tread rubber base layer provides a path of electrical conductivity to the running surface of the tread through said lateral tread running surface.
